(19) United States
(12) Patent Application Publication
(10) Pub. No.: US 2025/0175567 A1
(43) Pub. Date: May 29, 2025

(54) IMAGE FORMING APPARATUS, TERMINAL DEVICE, AND OPERATION METHOD

(71) Applicant: SEIKO EPSON CORPORATION, Tokyo (JP)

(72) Inventors: Yuichi FURUWATA, SHIOJIRI-SHI (JP); Kazumasa KONDO, SHIOJIRI-SHI (JP)

(21) Appl. No.: 18/959,795

(22) Filed: Nov. 26, 2024

(30) Foreign Application Priority Data
Nov. 29, 2023 (JP) 2023-201437

(51) Int. Cl. H04N 1/00

(52) U.S. Cl. CPC H04N 1/00938; H04N 1/00209; H04N 1/00413

(57) ABSTRACT

An image forming apparatus according to an aspect of the present disclosure includes a communication unit, a display configured to display an operation image, a transmission processor, and a reception processor. The transmission processor transmits display information based on the operation image displayed on the display to the terminal device via the communication unit. The reception processor receives an operation event, which was received by the terminal device, from the terminal device via the communication unit. When the reception processor receives first information including a predetermined plurality of operation events, the transmission processor transmits, to the terminal device, first display information representing a response result to the predetermined plurality of operation events represented by the first information as the display information.

The present application is based on, and claims priority from JP Application Serial Number 2023-201437, filed Nov. 29, 2023, the disclosure of which is hereby incorporated by reference herein in its entirety.

### BACKGROUND

### 1. Technical Field The present disclosure relates to an image

forming apparatus, a terminal device, and an operation method.

### 2. Related Art

JP-A-2019-220075 discloses a system for stably and rapidly transferring a moving image on a remote panel, which is a function of displaying an operation unit of an image forming apparatus via a network, without depending on a line speed of a public line or a geographical situation of a line.

JP-A-2019-220075 is an example of the related art.

Incidentally, in the remote panel, it may take time to reflect the user operation event in some cases, and the convenience is deteriorated. Note that the technology described in JP-A-2019-220075 is not a technology capable of solving such a problem.

Therefore, it is desired to develop a technique to shorten the time necessary to reflect a user operation event when displaying a part or all of an operation image of the image forming apparatus from the terminal device via the network to perform an operation to thereby improve the convenience of the user.

### SUMMARY

An image forming apparatus according to an aspect of the present disclosure includes a communication unit, a display unit configured to display an operation image, a transmission processing unit configured to transmit display information based on the operation image displayed on the display unit to a terminal device via the communication unit, and a reception processing unit configured to receive an operation event which was received by the terminal device from the terminal device via the communication unit, wherein when the reception processing unit receives first information including a predetermined plurality of operation events, the transmission processing unit transmits, as the display information, first display information representing a response result to the predetermined plurality of operation events represented by the first information to the terminal device.

A terminal device according to an aspect of the present disclosure includes an operation unit, a communication unit, a reception processing unit configured to receive display information based on an operation image displayed on a display unit of an image forming apparatus from the image forming apparatus via the communication unit, a display unit configured to display an operation image based on the display information received by the reception processing unit, and a transmission processing unit configured to transmit an operation event received by the operation unit to the image forming apparatus via the communication unit, wherein the transmission processing unit is configured to transmit first information including a predetermined plurality of operation events received by the operation unit to the image forming apparatus, and the reception processing unit is configured to receive first display information representing a response result to the predetermined plurality of operation events represented by the first information from the image forming apparatus as the display information when the transmission processing unit transmits the first information.

An operation method according to an aspect of the present disclosure includes executing, by an image forming apparatus including a communication unit and a display unit configured to display an operation image, transmission processing of transmitting display information based on the operation image displayed on the display unit to a terminal device via the communication unit, and executing, by the image forming apparatus, reception processing of receiving an operation event, which was received by the terminal device, from the terminal device via the communication unit, wherein in the transmission processing, when first information including a predetermined plurality of operation events was received in the reception processing, first display information representing a response result to the predetermined plurality of operation events represented by the first information is transmitted to the terminal device via the communication unit as the display information.

### BRIEF DESCRIPTION OF THE DRAWINGS

FIG. 1: is a block diagram illustrating a configuration example of an image forming system including an image forming apparatus and a terminal device according to an embodiment.

FIG. 2 is a flowchart illustrating a processing example of a terminal device in the image forming system in FIG. 1.

FIG. 3 is a flowchart illustrating a processing example when a mouse-down operation occurs in the terminal device in the image forming system in FIG. 1.

FIG. 4 is a flowchart illustrating a processing example when a mouse-up operation occurs in the terminal device in the image forming system in FIG. 1.

FIG. 5 is a flowchart illustrating a processing example when receiving a mouse-click operation in the image forming apparatus in the image forming system in FIG. 1.

FIG. 6 is a flowchart illustrating a processing example when performing the mouse-click operation in the image forming system in FIG. 1.

FIG. 7 is a schematic diagram illustrating a transition example of a display image in the processing example in FIG. 6.

FIG. 8 is a flowchart illustrating processing when performing the mouse-click operation in an image forming system according to a comparative example.

FIG. 9 is a flowchart illustrating a processing example when performing an icon-move operation in the image forming system in FIG. 1.

FIG. 10 is a schematic diagram illustrating a transition example of a display image in the processing example in FIG. 9.

FIG. 11 is a schematic diagram illustrating a transition example of the display image in the processing example in FIG. 9 subsequent to FIG. 10.

FIG. 12 is a flowchart illustrating processing when performing the icon-move operation in the image forming system according to the comparative example.

FIG. 13 is a schematic diagram illustrating a transition example of a display image in the processing in FIG. 12.

FIG. 14 is a schematic block diagram illustrating another configuration example of the image forming system including the image forming apparatus and the terminal device according to the embodiment.

FIG. 15 is a diagram showing an example of a hardware configuration of the apparatus.

### DESCRIPTION OF EMBODIMENTS

Hereinafter, an embodiment of the present disclosure will be described with reference to the drawings. Each of the drawings is merely an example showing the embodiment of the present disclosure. Further, all the elements described in the embodiment of the present disclosure are not necessarily essential elements of the present disclosure.

### Embodiment

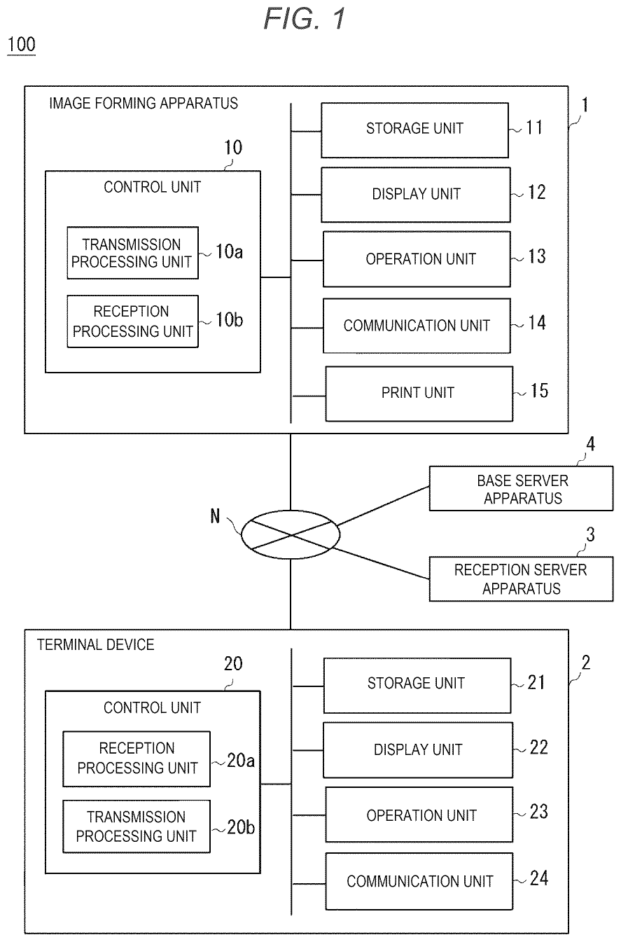

An image forming system including the image forming apparatus and the terminal device according to the embodiment will be described using FIG. 1. FIG. 1 is a block diagram illustrating a configuration example of such an image forming system.

As illustrated in FIG. 1, an image forming system (hereinafter referred to as the present system) 100 according to the present embodiment may include an image forming apparatus 1, a terminal device 2, a reception server apparatus 3, and a base server apparatus 4. The terminal device 2 may be coupled to the reception server apparatus 3 via a network N. Further, the reception server apparatus 3 may be coupled to the base server apparatus 4 via the network N. Further, the base server apparatus 4 may be coupled to the image forming apparatus 1 via the network N. Hereinafter, a description will be presented assuming that the present system 100 employs such a network configuration example.

Note that in FIG. 1, a network which couples the devices is represented by the same network N for the sake of simplification of the description, but a coupling configuration of the devices is not limited to this configuration, such as a configuration in which some or all of the devices are coupled to each other with different networks. Further, the present system 100 may employ a network configuration other than the network configuration example described above. For example, as long as the present system 100 includes the image forming apparatus 1 and the terminal device 2 coupled to the image forming apparatus via the network N, the present system 100 may adopt a configuration which is not provided with the reception server apparatus 3 and the base server apparatus 4. Further, the present system 100 may be a system in which the functions of the reception server apparatus 3 and the base server apparatus 4 are installed in the same server apparatus, or may be a system including three or more server apparatuses in which further function distribution is formed. That is, it is sufficient for the image forming apparatus 1 to have a configuration of performing communication with the terminal device 2 via at least one information processing apparatus such as at least one server apparatus. In this case, the terminal device 2 is configured to communicate with the image forming apparatus 1 via at least one information processing apparatus such as at least one server apparatus.

The present system enables the terminal device 2 to operate an operation image of the image forming apparatus 1. The operation image provided from the image forming apparatus 1 to the terminal device 2 as described above or the provision of the operation image may be referred to as a remote panel or the like. The reception server apparatus 3 may be a server apparatus that provides reception processing of an operation from the terminal device 2 to the terminal device 2. The base server apparatus 4 may be a server apparatus that provides the image forming apparatus 1 with processing of operating the operation image of the image forming apparatus 1 based on the operation which has been received by the reception server apparatus 3.

### Schematic Configuration of Image Forming Apparatus 1

As illustrated in FIG. 1, the image forming apparatus 1 may include a control unit 10, a storage unit 11, a display unit 12, an operation unit 13, a communication unit 14, and a print unit 15.

The control unit 10 of the image forming apparatus 1 may also be referred to as a controller, and performs overall control of the image forming apparatus 1. Although described later in detail, the control unit 10 may include a transmission processing unit 10a and a reception processing unit 10b.

The control unit 10 may include an arithmetic processing device such as a central processing unit (CPU) or a graphics processing unit (GPU), a working memory, and a storage device that stores a control program, parameters, and so on. The control unit 10 may also be implemented as a system on a chip (SoC). As is understood from these examples, the control unit 10 may be provided with a configuration in which the control program is stored in an executable state. Note that the control unit 10 may have a configuration in which the control program is stored as a circuit configuration such as a field-programmable gate array (FPGA), or may be configured as a dedicated circuit. The transmission processing unit 10a and the reception processing unit 10b can be implemented as the program described above. The program described above may include a program for realizing the functions of the transmission processing unit 10a and the reception processing unit 10b in cooperation with the storage unit 11, the display unit 12, the operation unit 13, and the communication unit 14. Alternatively, the program described above may include a program for realizing the functions of the transmission processing unit 10a and the reception processing unit 10b in cooperation with the storage unit 11, the display unit 12, the operation unit 13, the communication unit 14, and the print unit 15.

The storage unit 11 is, for example, a hard disk drive, a solid state drive, or other memory devices. A part of the memory provided to the control unit 10 may be regarded as the storage unit 11. The storage unit 11 may also be regarded as a part of the control unit 10.

The display unit 12 is a region for displaying information. The display unit 12 can display an operation image that is a user interface (UI) image as the information. This operation image can be stored in the storage unit 11. The display unit 12 is formed of, for example, a display device such as a liquid crystal display or an organic EL display. The display unit 12 may have a configuration including a display and a drive circuit for driving the display.

The operation unit 13 is a region that receives an operation or an input by a user, and may also be referred to as an operation reception unit. The operation unit 13 may include a touch panel or a touch sensor installed in the display unit 12. In this case, by the user performing a touch operation on the operation image displayed on the display unit 12, the operation unit 13 can receive an operation corresponding to the area where the touch operation is performed. Such the display unit 12 for displaying an operation image and such the operation unit 13 including the touch panel or the touch sensor installed in the display unit 12 can configure an operation panel of the image forming apparatus 1. Besides the above, the operation unit 13 may also include, for example, a physical button group. Some buttons of the physical button group may be configured to be capable of receiving an operation on the operation image. Obviously, some or all of the buttons of the physical button group may be configured to receive operations independent of the operation image.

The communication unit 14 may be a single communication interface or a plurality of communication interfaces for the image forming apparatus 1 to perform communication with a plurality of external apparatuses with wire or wirelessly in conformity with a predetermined communication protocol including a predetermined communication standard. The external apparatus is a device having a communication function such as a personal computer (PC), a server apparatus, a smartphone, or a tablet terminal. In the network configuration example described above, the external apparatus when performing communication regarding processing related to the operation image includes the base server apparatus 4 as a result.

The communication unit 14 can transmit display information for displaying the operation image in the terminal device 2 to the terminal device 2 via the base server apparatus 4 and the reception server apparatus 3. Note that the display information may be the operation image itself. Further, the communication unit 14 can receive an operation event received by the terminal device 2 from the terminal device 2 via the reception server apparatus 3 and the base server apparatus 4.

In addition, the communication unit 14 can receive a print target file from the external apparatus. The external apparatus that transmits the print target file may be a terminal device other than the terminal device 2. Note that the communication unit 14 may be configured to be able to receive the print target file from the terminal device 2 directly or via the reception server apparatus 3 and the base server apparatus 4.

The print unit 15 performs printing on a medium based on, for example, a print target file received from the terminal device other than the terminal device 2 or the terminal device 2 via the communication unit 14, or a print target file obtained by performing image reading with a scanner (not shown). Thus, an image represented by the print target file is formed in the medium. A printing method in the print unit 15 does not matter, and various printing methods such as an inkjet printing method and a laser printing method can be applied. The image forming apparatus 1 may be referred to as an inkjet printer when the inkjet printing method is employed, and may be referred to as a laser printer when the laser printing method is employed.

### Schematic Configuration of Terminal Device 2

The terminal device 2 may be a device having a communication function such as a smartphone, a tablet terminal, or a PC. The terminal device 2 is not limited to a portable type device, and may be an installation type device. As illustrated in FIG. 1, the terminal device 2 may include a control unit 20, a storage unit 21, a display unit 22, an operation unit 23, and a communication unit 24.

The control unit 20 of the terminal device 2 may be referred to as a controller, and performs overall control of the terminal device 2. Although described later in detail, the control unit 20 may include a reception processing unit 20a and a transmission processing unit 20b.

The control unit 20 may include an arithmetic processing device such as a CPU or a GPU, a working memory, and a storage device that stores a control program, parameters, and so on. The control unit 20 may be configured as an SoC. As is understood from these examples, the control unit 20 may be provided with a configuration in which the control program is stored in an executable state. Note that the control unit 20 may be configured to store the control program as a circuit configuration such as an FPGA, or may be configured as a dedicated circuit. The reception processing unit 20a and the transmission processing unit 20b can be implemented as the program described above. The program described above may include a program for realizing the functions of the reception processing unit 20a and the transmission processing unit 20b in cooperation with the storage unit 21, the display unit 22, the operation unit 23, and the communication unit 24.

The storage unit 21 is, for example, a hard disk drive, a solid state drive, or other memory devices. A part of the memory provided to the control unit 20 may be regarded as the storage unit 21. The storage unit 21 can also be regarded as a part of the control unit 20.

The display unit 22 is a region for displaying information, and is configured with a display device such as a liquid crystal display or an organic EL display. The display unit 22 may have a configuration including a display and a drive circuit for driving the display.

The operation unit 23 is a region that receives an operation or an input by a user, and may also be referred to as an operation reception unit. The operation unit 23 can be realized by any one or more of, for example, physical buttons, a touch panel or a touch sensor installed in the display unit 22, a pointing device, a keyboard, and so on. In a configuration in which the operation unit 23 includes the touch panel or the touch sensor, the display unit 22 and the touch panel may collectively be referred to as an operation panel of the terminal device 2.

The communication unit 24 may be a single communication interface or a plurality of communication interfaces for the terminal device 2 to perform communication with a single external apparatus or a plurality of external apparatuses with wire or wirelessly in conformity with a predetermined communication protocol including a predetermined communication standard. In the network configuration example described above, the external apparatus when performing communication regarding processing related to the operation image includes the reception server apparatus 3 as a result.

The communication unit 24 can receive display information for causing the terminal device 2 to display an operation image, from the image forming apparatus 1 via the reception server apparatus 3 and the base server apparatus 4. As described above, the display information may be the operation image itself. Further, the communication unit 24 can transmit the operation event received by the operation unit 23 to the image forming apparatus 1 via the base server apparatus 4 and the reception server apparatus 3.

In addition, the communication unit 24 may be configured to be able to transmit the print target file to the image forming apparatus 1 directly or via the reception server apparatus 3 and the base server apparatus 4.

### Schematic Configuration of Reception Server Apparatus 3 And Base Server Apparatus 4

The reception server apparatus 3 and the base server apparatus 4 all may be server computers each provided with a function of receiving operations and a function of managing at least a remote panel, although the detailed description of each of the reception server apparatus 3 and the base server apparatus 4 is omitted. Any of the server computers may include a control unit, a communication unit, and a storage unit although not shown in the drawings.

This control unit may include an arithmetic processing device such as a CPU or a GPU, a working memory, and a storage device that stores a control program, parameters, and so on. This control unit may be configured as an SoC. As is understood from these examples, this control unit may be provided with a configuration in which the control program is stored in an executable state. Note that this control unit may be configured to store the control program as a circuit configuration such as an FPGA, or may be configured as a dedicated circuit.

The control unit of the reception server apparatus 3 receives the display information from the image forming apparatus 1 via the base server apparatus 4, and transmits the display information to the terminal device 2. Further, the control unit of the reception server apparatus 3 receives an operation event from the terminal device 2 and transmits the operation event to the image forming apparatus 1 via the base server apparatus 4. The control unit of the reception server apparatus 3 can implement such a function related to the transmission and the reception of the information as, for example, a program.

The control unit of the base server apparatus 4 receives the display information from the image forming apparatus 1, and transmits the display information to the terminal device 2 via the reception server apparatus 3. Further, the control unit of the base server apparatus 4 receives an operation event from the terminal device 2 via the reception server apparatus 3, and transmits the operation event to the image forming apparatus 1. The control unit of the base server apparatus 4 can implement these functions related to the transmission and the reception of the information as, for example, a program.

The communication unit described above may be a single communication interface or a plurality of communication interfaces for the server computer to perform communication with a single external apparatus or a plurality of external apparatuses with wire or wirelessly in conformity with a predetermined communication protocol including a predetermined communication standard. In the network configuration example described above, the communication unit in the reception server apparatus 3 can communicate with the terminal device 2 as the external apparatus and the base server apparatus 4. In the network configuration example described above, the communication unit in the base server apparatus 4 can communicate with the image forming apparatus 1 as the external apparatus and the reception server apparatus.

The storage unit described above is, for example, a hard disk drive, a solid state drive, or other memory devices. A part of the memory provided to the control unit described above may be regarded as this storage unit. In other words, the storage unit in the server computer can be regarded as a part of the control unit in the server computer.

In the network configuration example described above, the storage unit in the reception server apparatus 3 stores information for managing communication with the base server apparatus 4, information for managing communication with the specific terminal device 2, and so on. By managing the communication with the specific terminal device 2, it is possible to restrict access to the reception server apparatus 3 from a terminal device that is not stored, that is, an unregistered terminal device.

In the network configuration example described above, the storage unit in the base server apparatus 4 stores information for managing communication with the reception server apparatus 3, device information of the specific image forming apparatus 1, information for managing communication with the image forming apparatus 1, and so on. By managing communication with the specific image forming apparatus 1, it is possible to restrict access to the reception server apparatus 3 from the image forming apparatus that is not stored, that is, an unregistered image forming apparatus.

### Specific Configuration of Present System 100

Details of the control unit 10 of the image forming apparatus 1 will be described together with details of the terminal device 2. In the present system 100, as a general flow, the terminal device 2 accesses the reception server apparatus 3, receives display information based on the operation image displayed on the display unit 12 of the image forming apparatus 1, and causes the display unit 22 to display the operation image based on the display information. Then, the operation unit 23 of the terminal device 2 receives a user operation on the operation image, and transmits an operation event representing the user operation to the reception server apparatus 3. The reception server apparatus 3 transmits the operation event to the image forming apparatus 1 via the base server apparatus 4. The image forming apparatus 1 receives an operation on the operation image based on the operation event thus received, and thus, it is possible to change the operation image by the transition to the next operation image or the like.

First, a configuration example of the image forming apparatus 1 side will be described. As described above, the control unit 10 of the image forming apparatus 1 may include the transmission processing unit 10a and the reception processing unit 10b.

The transmission processing unit 10a transmits the display information based on the operation image displayed on the display unit 12 to the terminal device 2 via the communication unit 14. In the network configuration example described above, the transmission of such display information by the transmission processing unit 10a is executed via the base server apparatus 4 and the reception server apparatus 3. The display information is information displayed on a screen of the display unit 12, and can therefore also be referred to as screen information. Further, the display information can be displayed on the display unit 22 of the terminal device 2 using, for example, a Web browser, and in this case, the display information can also be referred to as Web screen information. As in this example, the transmission processing unit 10a may transmit the display information as information to be displayed on the browser of the terminal device 2.

The reception processing unit 10b receives the operation event received by the terminal device 2 from the terminal device 2 via the communication unit 14. In the network configuration example described above, the reception of such an operation event by the reception processing unit 10b is executed via the reception server apparatus 3 and the base server apparatus 4. This operation event is an event representing an operation received via the operation image displayed based on the display information transmitted to the terminal device 2. Note that the reception processing unit 10b may also be referred to as an acquisition processing unit since the reception processing unit 10b acquires the operation event from the terminal device 2.

It results in that the image forming apparatus 1 has a function of remotely providing an operation panel to the terminal device 2 by such transmission and reception of information by the transmission processing unit 10a and the reception processing unit 10b, that is, a function of providing a remote panel.

The transmission processing unit 10a in the present embodiment further performs the following processing. That is, when the reception processing unit 10b receives first information including the predetermined plurality of operation events, the transmission processing unit 10a transmits, to the terminal device 2, first display information representing the response result to the predetermined plurality of operation events represented by the first information as the display information.

As described with respect to the operation event, it results in that the reception of the first information is also executed via the communication unit 14. In the network configuration example described above, the reception of such first information by the reception processing unit 10b is also executed via the reception server apparatus 3 and the base server apparatus 4. Further, it results in that the first display information is transmitted as the display information when the condition described above is satisfied. Therefore, it results in that the transmission of the first information by the transmission processing unit 10a is also executed via the communication unit 14. In the network configuration example described above, the transmission of such first display information by the transmission processing unit 10a is also executed via the base server apparatus 4 and the reception server apparatus 3.

Then, a configuration example of the terminal device 2 side will be described. As described above, the control unit 20 of the terminal device 2 may include the reception processing unit 20a and the transmission processing unit 20b.

The reception processing unit 20a receives the display information based on the operation image displayed on the display unit 12 of the image forming apparatus 1 from the image forming apparatus 1 via the communication unit 24. In the network configuration example described above, the reception of such display information by the reception processing unit 20a is executed via the base server apparatus 4 and the reception server apparatus 3. Note that the reception processing unit 20a may also be referred to as an acquisition processing unit since the reception processing unit 20a acquires the display information from the image forming apparatus 1.

Then, the display unit 22 displays the operation image based on the display information received by the reception processing unit 20a. Further, as described above, the display information may be displayed on the display unit 22 using, for example, a Web browser. As in this example, the reception processing unit 20a may receive the display information as information to be displayed by the browser of the terminal device 2.

Further, the transmission processing unit 20b transmits the operation event received by the operation unit 23 to the image forming apparatus 1 via the communication unit 24. In the network configuration example described above, the transmission of such an operation event by the transmission processing unit 20b is executed via the reception server apparatus 3 and the base server apparatus 4. Examples of the operation event include an event of a click operation or a touch operation by a pointing device on the operation image displayed on the display unit 22. Note that the description will hereinafter be presented referring the pointing device to as a mouse, and referring the operation by the mouse to as a mouse operation.

It results in that the terminal device 2 has a function of remotely enjoying the provision of an operation panel from the image forming apparatus 1 due to such transmission and reception of the information by the reception processing unit 20a and the transmission processing unit 20b, that is, a function of enjoying a remote panel.

The transmission processing unit 20b and the reception processing unit 20a in the present embodiment further perform the following processing. That is, the transmission processing unit 20b transmits the first information including the predetermined plurality of operation events received by the operation unit 23 to the image forming apparatus 1. As described with respect to the operation event, it results in that the transmission of the first information is also executed via the communication unit 24. In the network configuration example described above, the transmission of such first information by the transmission processing unit 20b is also executed via the reception server apparatus 3 and the base server apparatus 4.

Then, when the transmission processing unit 20b transmits the first information, the reception processing unit 20a receives, from the image forming apparatus 1, the first display information indicating a response result to the predetermined plurality of operation events described above represented by the first information as the display information. It results in that the first display information is received as the display information when such a condition as described above is satisfied. Therefore, it results in that the reception of the first display information by the reception processing unit 20a is also executed via the communication unit 24. In the network configuration example described above, the reception of such first display information by the reception processing unit 20a is also executed via the base server apparatus 4 and the reception server apparatus 3.

### Processing Example of Present System 100

The configurations of the image forming apparatus 1 and the terminal device 2 are described hereinabove. In the above configurations, it is possible to always transmit the first information including the predetermined plurality of operation events described above.

On the other hand, the terminal device 2 may determine whether to transmit the first information based on the condition of the communication time, and may transmit the first information only when the condition is satisfied. The communication time can refer to a time required for acquiring the display information such as the operation image for one operation event. In this case, it results in that the image forming apparatus 1 sends back the first display information when the first information is received. On the other hand, when the condition is not satisfied, it is sufficient for the terminal device 2 to individually transmit the operation events thus received. In this case, it results in that the image forming apparatus 1 sends back the display information representing a response result to each of the operation events, which is not the first display information, to the individual operation event thus received.

In this example, the predetermined plurality of operation events described above which the terminal device 2 transmits an inclusion of the first information is assumed as a plurality of operation events determined based on the following communication time with respect to the communication with the image forming apparatus 1 by the communication unit 24.

The communication time may refer to a time it takes from the transmission of the operation event to the reception of the display information as a response thereto. For example, the communication time may be a time it takes from the start of an operation event for requesting the initial display information to the reception of the display information thereof. The operation event for requesting the initial display information may be assumed as an operation event in which, for example, the user opens a page for accessing the image forming apparatus 1 in the browser. Note that it is sufficient for this page in the network configuration example described above to be a page to access the reception server apparatus 3 or a page for designating the image forming apparatus 1 on that page. Further, it is possible to arrange that the communication time is obtained, for example, when the terminal device 2 starts or resumes the communication with the image forming apparatus 1. Further, it is preferable for the transmission processing unit 20b to have a configuration of transmitting the first information based on the communication time.

More specifically, it is preferable for the predetermined plurality of operation events described above to be a plurality of operation events received when the communication time it takes from the transmission of the operation event to the reception of the display information as a response thereof with respect to the communication with the image forming apparatus 1 by the communication unit 24 is longer than a predetermined time. That is, it is preferable for the transmission processing unit 20b to collectively transmit the plurality of operation events to the image forming apparatus 1 side as the first information when the time required to acquire the display information from the image forming apparatus 1 exceeds the predetermined time.

When viewed from the image forming apparatus 1 side, it results in that the predetermined plurality of operation events described above satisfy the following condition, and it results in that when this condition is satisfied, the predetermined plurality of operation events are received as an inclusion of the first information. That is, the predetermined plurality of operation events described above which the image forming apparatus 1 receives as the inclusion of the first information become the plurality of operation events determined based on the communication time it takes from the transmission to the reception of the operation event in the terminal device 2 with respect to the communication with the terminal device 2 by the communication unit 14. Then, the reception processing unit 10b receives the first information based on this communication time. More specifically, the predetermined plurality of operation events 1 may be a plurality of operation events received when the communication time described above is longer than the predetermined time with respect to the communication with the terminal device 2 by the communication unit 14.

As described above, in the terminal device 2, when it is determined that it takes time to acquire the display information from the image forming apparatus 1, the contents of the plurality of operation events by the user may be collectively transmitted in one communication. Further, in this case, in the image forming apparatus 1, the response results to the plurality of operation events described above may be aggregated into one communication and sent back as the response. This enables the present system 100 to perform the efficient communication by reducing the number of times of communication.

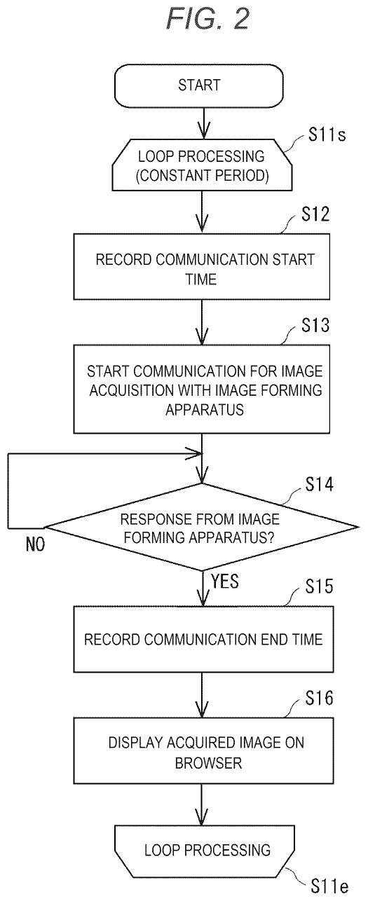

A flow of processing in the terminal device 2 with such a determination will be described using FIG. 2. FIG. 2 is a flowchart illustrating a processing example of the terminal device 2 in the present system 100.

The processing example in FIG. 2 shows an example of the update processing of the terminal device 2 periodically updating the operation image displayed in the image forming apparatus 1. Here, an example in which the display information transmitted from the image forming apparatus 1 is an operation image to be displayed on a browser that can be displayed on the display unit 22 of the terminal device 2 will be cited.

As the update processing, the terminal device 2 performs loop processing of the processing represented by steps S12 to S16 at a constant period (steps S11s to S11e). This period is not limited, but may be, for example, an interval of 0.3 second to 0.5 second.

In this loop processing, first, the reception processing unit 20a records the communication start time in the internal memory or the storage unit 21 (step S12). In step S12, for example, the communication start time can be recorded as a variable on the browser. The communication start time can be recorded as a start time of the operation event by the user. Then, the reception processing unit 20a instructs the communication unit 24 to perform the communication for acquiring the operation image with the image forming apparatus 1 to thereby start the communication in the communication unit 24 (step S13).

Then, the reception processing unit 20a determines whether there is a response from the image forming apparatus 1 (step S14). This response is a reply of the operation image.

when the response is received from the image forming apparatus 1, that is, when YES is determined in step S14, the reception processing unit 20a performs the following processing. That is, the reception processing unit 20a records the communication end time on the internal memory or the storage unit 21 (step S15). In step S15, for example, the communication end time can be recorded as a variable on the browser. Further, in this case, the reception processing unit 20a displays the operation image acquired as the response on the browser (step S16). Obviously, the order of step S15 and step S16 does not matter.

In the processing example described above, the communication start time and the communication end time recorded in steps S12, S15 can be used to obtain the time it takes to acquire the operation image, that is, the communication time. This communication time can be used to determine whether to transmit the first information as described above.

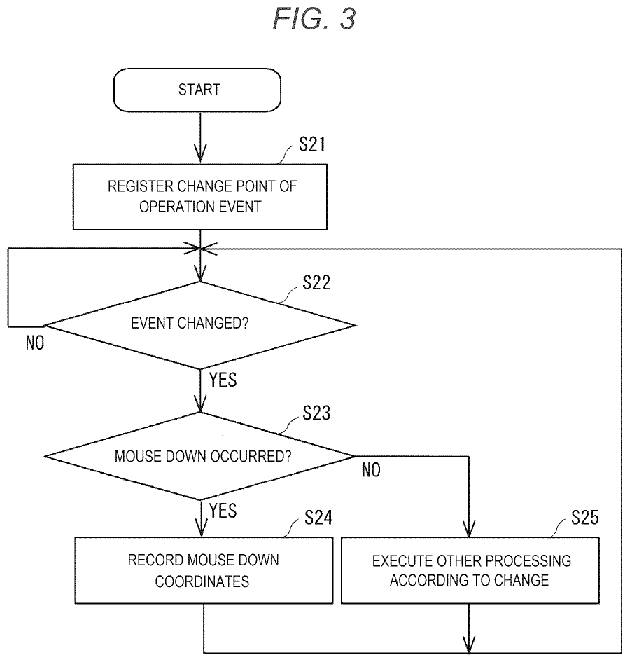

Then, a more specific processing example will be described using FIG. 3 to FIG. 5 citing a click operation with the mouse as an example. The click operation with the mouse includes an operation of pressing down a click button of the mouse and an operation of raising the click button to be restored. The description will be presented referring the operation of pressing down the click button of the mouse to as a mouse-down operation, and the operation of raising the click button of the mouse to be restored to as a mouse-up operation. The mouse-down operation corresponds to an operation in which a touch is detected by a touch panel or a touch sensor in a touch operation. The mouse-up operation corresponds to an operation in which, in the touch operation, a touch on the touch panel or the touch sensor is not detected after the touch is detected. Therefore, the following description can be similarly applied to the touch operation.

First, a processing example when a mouse-down operation occurs in the terminal device 2 in the present system 100 will be described using FIG. 3. FIG. 3 is a flowchart for explaining such a processing example.

In the present system 100, description will be presented from a stage in which the image forming apparatus 1 provides an operation image to the terminal device 2, that is, a stage in which provision of a remote panel is started. First, the transmission processing unit 20b of the terminal device 2 registers a change point of an operation event that is an event representing a user operation from the operation unit 23 (step S21). Here, it results in that the change point to be registered refers to the coordinates currently pointed by the mouse, and refers to the change start point. Note that the coordinates may be, for example, an X coordinate and a Y coordinate in the operation image. Regarding this point, the same applies to the following coordinates.

Then, the transmission processing unit 20b refers to the change point thus registered to determine whether there is a change in the operation event by the user operation (step S22). When NO is determined in step S22, a change in the operation event is awaited. When YES is determined in step S22, the transmission processing unit 20b determines whether the change is a change due to the mouse-down operation, that is, whether a mouse-down operation occurred (step S23).

When YES is determined in step S23, the transmission processing unit 20b records (step S24) the coordinates where the mouse-down operation occurred, and returns to step S22. After step S24, the transmission related to the operation event of the mouse-down operation to the image forming apparatus 1 side is not performed, and it results in that the mouse-up operation described later is awaited. Note that when NO is determined in step S23, the transmission processing unit 20b or the control unit 20 executes processing corresponding to another operation event detected in step S22, and returns to step S22.

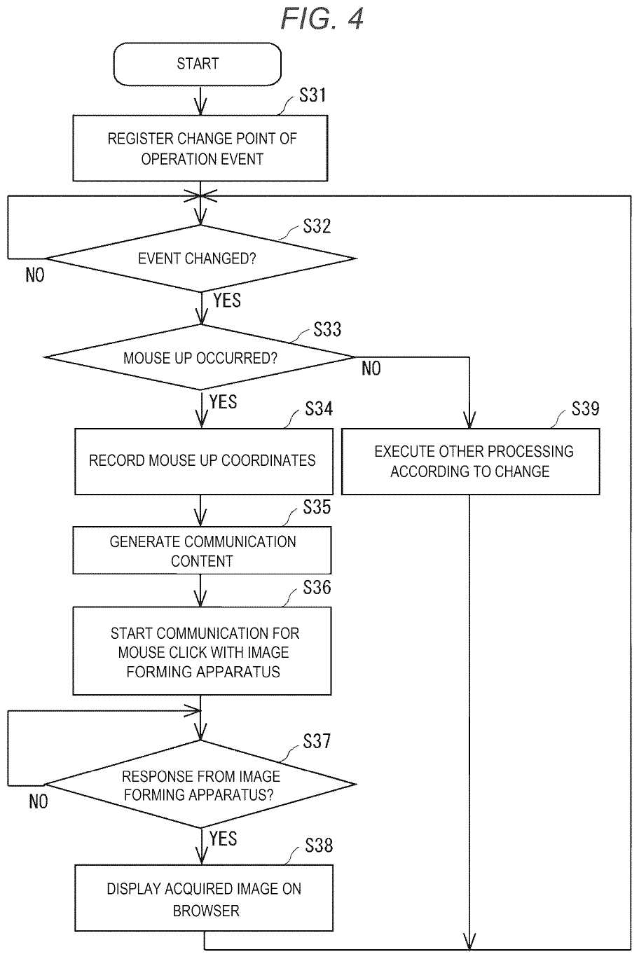

Then, a processing example when the mouse-up operation occurs in the terminal device 2 in the present system 100 will be described using FIG. 4. FIG. 4 is a flowchart illustrating such a processing example.

Here, the description will also be presented from the stage in which the image forming apparatus 1 provides an operation image to the terminal device 2, that is, the stage in which provision of the remote panel is started, in the present system 100. Note that, in practice, the processing is performed after the mouse-down operation is performed according to the processing example in FIG. 3.

First, the transmission processing unit 20b of the terminal device 2 registers (step S31) the change point in the operation event similarly to step S21. It results in that the change point to be registered here also refers to the coordinates currently pointed by the mouse, and refers to the change start point.

Then, the transmission processing unit 20b refers to the change point thus registered to determine whether there is a change in the operation event by the user operation (step S32). When NO is determined in step S32, a change in the operation event is awaited. When YES is determined in step S32, the transmission processing unit 20b determines whether the change is a change due to the mouse-up operation, that is, whether a mouse-up operation occurred (step S33).

When YES is determined in step S33, the transmission processing unit 20b records (step S34) the coordinate where the mouse-up operation occurred in association with the coordinate in which the mouse-down operation occurred, and which was recorded in step S24. Then, the transmission processing unit 20b generates communication content from these coordinates (step S35). The communication content to be generated is assumed as the first information representing a click operation with the mouse in the coordinate where the mouse-down operation occurred or the coordinate where the mouse-up operation occurred. Then, the transmission processing unit 20b starts the communication for the mouse click, which is the communication content, to the image forming apparatus 1 side via the communication unit 24 (step S36).

Then, the reception processing unit 20a determines (step S37) whether there is a reply of the first display information that is a response from the image forming apparatus 1 side. When NO is determined in step S37, the reply is awaited as a result. When YES is determined in step S37, the reception processing unit 20a displays (step S38) the operation image on the browser based on the first display information received, and then returns to step S32. Note that when NO is determined in step S33, the transmission processing unit 20b or the control unit 20 executes the processing corresponding to another operation event detected in step S22, and then returns to step S32.

In the example described using FIG. 3 to FIG. 5, it results in that the first information includes, as the predetermined plurality of operation events, a first event that is the operation event for starting designation of selection and a second event that is the operation event for ending the designation of the selection. The selection here may refer to selection of the position of the operation image, and more specifically, may refer to selection of an object that is located at that position, and that the operation image includes.

As illustrated in FIG. 4, when the terminal device 2 transmits the information representing the mouse-click operation as the first information, it results in that the image forming apparatus 1 transmits the first display information as described in step S37.

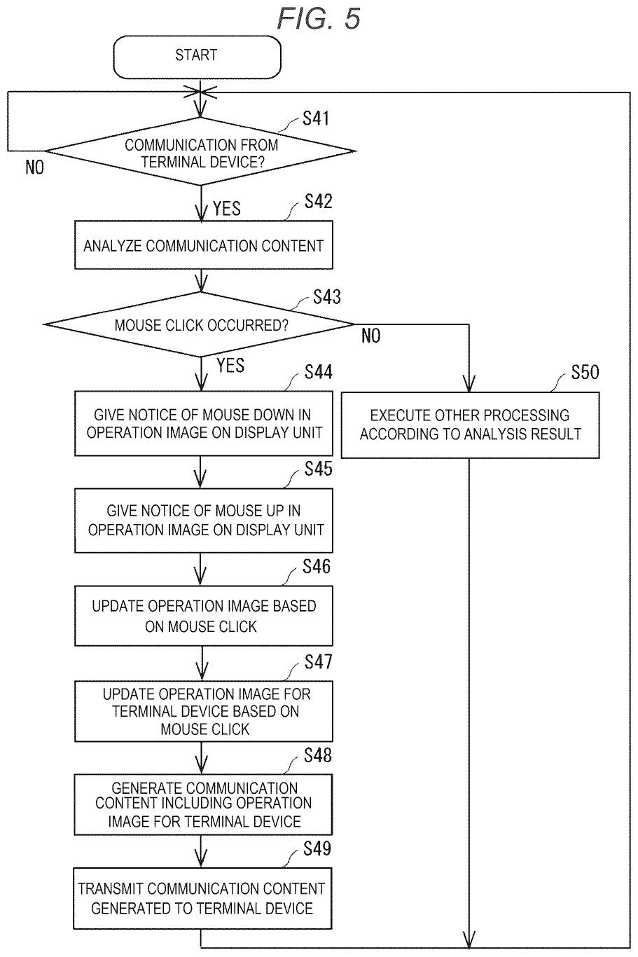

Then, a processing example when receiving the mouse-click operation of the image forming apparatus 1 in the present system 100 will be described using FIG. 5 including such processing. FIG. 5 is a flowchart illustrating such a processing example.

First, the reception processing unit 10b of the image forming apparatus 1 determines whether there is the communication from the terminal device 2 (step S41). When there is no communication, the communication is awaited. When there is the communication, that is, when YES is determined in step S41, the reception processing unit 10b analyzes (step S42) the communication content. The reception processing unit 10b determines whether the mouse-click operation occurred in the terminal device 2 based on the analysis result (step S43).

When the mouse-click operation occurred, that is, when YES is determined in step S43, the reception processing unit 10b gives notice (steps S44, S45) of the mouse-down operation and the mouse-up operation in the UI image, which is the operation image of the display unit 12. Note that the order of steps S44, S45 does not matter.

Upon reception of this notice, the control unit 10 updates the operation image based on the mouse-click operation, and causes the display unit 12 to display the operation image (step S46). Then, in response to this notice, the transmission processing unit 10a updates the operation image for the terminal device, which is an operation image to be displayed on the terminal device 2, based on the mouse-click operation (step S47). Note that the order of steps S46, S47 does not matter.

Then, the transmission processing unit 10a generates the communication content so as to include the operation image for the terminal device thus updated or the first display information generated based on the operation image for the terminal device (step S48). Then, the transmission processing unit 10a transmits (step S49) the communication content thus generated to the terminal device 2 via the communication unit 14, and then returns to step S41. Note that when NO is determined in step S43, the transmission processing unit 10a or the control unit 10 executes the processing corresponding to the result analyzed in step S42, and then returns to step S41.

Further, as illustrated in FIG. 2, the terminal device 2 may periodically perform image update in the background in order to display the change in the operation image of the image forming apparatus 1 in real time even when there is no operation by the user. In the present system 100, it is possible to coordinate the processing with respect to this image update. Specifically, when an image update timing occurs between the mouse-down operation and the mouse-up operation, in the present embodiment, for example, by waiting the image update until the mouse-up operation is performed, and replacing the image update with the image update by the mouse-click operation, it is possible to coordinate the processing of the image update in the communication response.

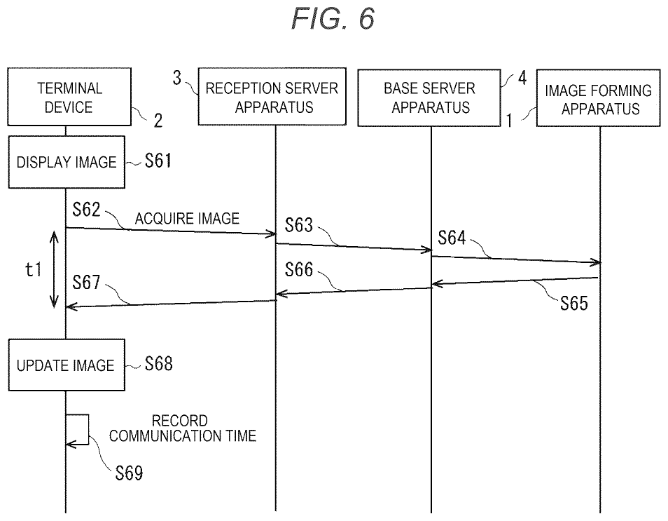

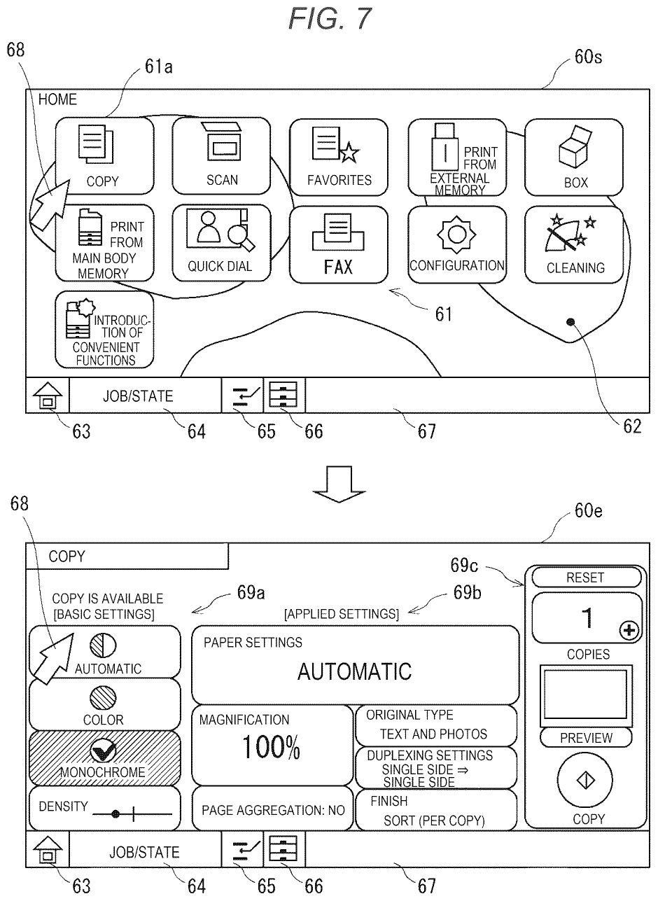

Then, the description of the overall processing example when performing the mouse-click operation in the present system 100 will be presented citing an example of the operation image using FIG. 6 and FIG. 7. FIG. 6 is a flowchart illustrating a processing example when performing the mouse-click operation in the present system 100. FIG. 7 is a schematic diagram illustrating a transition example of a display image in the processing example in FIG. 6.

First, upon reception of the provision of the remote panel, the terminal device 2 displays an operation image such as an operation image 60s in FIG. 7 (step S61). The operation image 60s may include an icon group 61 representing functions such as copy and scan in the image forming apparatus 1. Further, the operation image 60s may also include a background image 62. In addition, the operation image 60s may include a home button 63 that returns to a home image when it is not the home image. Further, the operation image 60s may include a button 64 for making the transition to the operation image representing a current state of a print job or the image forming apparatus 1, a button 65 for performing interrupt processing, a button 66 for selecting a tray of the medium, and an information field 67 for displaying various kinds of information. Obviously, the example of the operation image 60s is not limited thereto, and other buttons may be displayed, or an image that does not include some or all of the illustrated buttons, icons, and so on may be adopted as long as the image is an operation image. Further, in FIG. 7, it results in that in the operation image 60s, a cursor 68 of the mouse is displayed at, for example, a predetermined position.

Then, the terminal device 2 receives an operation to the operation image 60s with the operation unit 23 to request the reception server apparatus 3 to acquire the next operation image, that is, the operation image reflecting the operation (step S62). In FIG. 7, it results in that the operation is received from the state where the cursor 68 of the mouse is displayed in the operation image 60s. Hereinafter, the description will be presented citing the example in which an icon 61a of the copy function is clicked as an operation in step S62. In this case, in step S62, it results in that the mouse-down and mouse-up operations are collectively contained in an acquisition request of the operation image as the first information.

The reception server apparatus 3 that received the request to acquire the operation image transmits the request to the base server apparatus 4 (step S63). The base server apparatus 4 received the request transmits the request to the image forming apparatus 1 (step S64).

The image forming apparatus 1 updates the operation image for the terminal device 2 and then transmits the operation image thus updated to the base server apparatus 4 as the first display information (step S65) in such a manner as illustrated in FIG. 5. The base server apparatus 4 that received the first display information transmits that first display information to the reception server apparatus 3 (step S66). The reception server apparatus 3 that received the first display information transmits that first display information to the terminal device 2 (step S67).

The terminal device 2 updates the operation image based on the first display information received (step S68). It results in that with this update, the operation image 60s makes the transition to an operation image 60e related to the copy function. Note that the operation image 60e may include, for example, a basic setting button group 69a, an applied setting button group 69b, and a button group 69c used when executing copy, while the cursor 68 is displayed. In addition, the terminal device 2 records a communication time t1 it takes until the update (step S69). Note that the order of steps S68, S69 does not matter.

### Advantage of Present Embodiment

According to the present embodiment, it is possible to shorten the time necessary to reflect a user operation event when displaying a part or all of an operation image of the image forming apparatus 1 from the terminal device 2 via the network to perform an operation to thereby improve the convenience of the user. This is because, in the present embodiment, the number of times of communication can be reduced by aggregating the user operation event and response data thereof into one communication, and efficient communication is possible.

Therefore, according to the present embodiment, even in a network environment in which the communication speed is low such as when the communication path between the terminal device 2 and the image forming apparatus 1 is long regardless of their physical positions, it is possible to improve the reaction speed of the remote panel to the user operation. In particular, according to the present embodiment, it is possible to improve the reaction speed of the remote panel to the user operation only by changing the programs of the terminal device 2 and the image forming apparatus 1 without requiring hardware costs such as an enhancement of the server apparatus and the communication line.

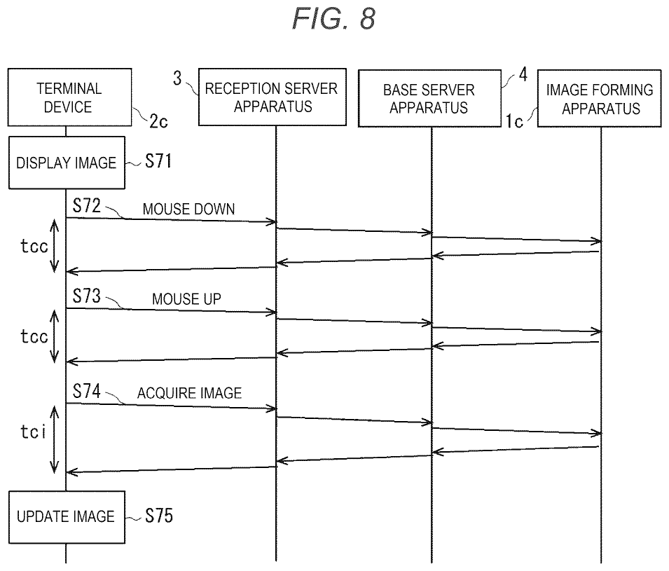

The advantages described above will be described by comparison with a comparative example using FIG. 8. FIG. 8 is a flowchart illustrating processing when performing the mouse-click operation in the image forming system according to the comparative example. As shown in FIG. 8, the image forming system according to the comparative example includes, instead of the terminal device 2 and the image forming apparatus 1, a terminal device 2c that does not include a function related to the transmission of the first information and an image forming apparatus 1c that does not include a function related to the transmission of the first display information.

In the comparative example, the terminal device 2c displays the operation image 60s similarly to step S61 (step S71). Then, the terminal device 2c receives the mouse-down operation on the operation image 60s, transmits the information to the reception server apparatus 3, and requests the response thereto (step S72). It results in that the request is thereafter received by the image forming apparatus 1c on substantially the same path as in FIG. 6. It results in that the image forming apparatus 1c that received this request performs a response to the reception of the request via the base server apparatus 4 and the reception server apparatus 3 on substantially the same path as in FIG. 6. The communication time it takes from the start of step S72 to the response is defined as a communication time tcc.

Then, the terminal device 2c receives the mouse-up operation on the operation image, transmits the information to the reception server apparatus 3, and requests the response thereto (step S73). It results in that the request is thereafter received by the image forming apparatus 1c on substantially the same path as in FIG. 6. It results in that the image forming apparatus 1c that received this request performs a response to the reception of the request via the base server apparatus 4 and the reception server apparatus 3 on substantially the same path as in FIG. 6. The communication time it takes from the start of step S73 to the response is also equivalent to the communication time tcc.

Then, the terminal device 2c requests the reception server apparatus 3 to acquire the operation image thus updated (step S74). It results in that the request is thereafter received by the image forming apparatus 1c on substantially the same path as in FIG. 6. It results in that the image forming apparatus 1c that received this request performs a response to the reception of the request via the base server apparatus 4 and the reception server apparatus 3 on substantially the same path as in FIG. 6. The communication time it takes from the start of step S74 to the response includes the operation image or information for displaying the operation image, and therefore becomes a communication time tci longer than the communication time tcc.

The terminal device 2c updates the operation image based on the response received (step S75). It results in that with this update, the operation image 60s makes the transition to the operation image 60e related to the copy function.

As described above, in the image forming system according to the comparative example, a total of three times of communication, namely the mouse-down operation, the mouse-up operation, and the image acquisition, are performed internally until the next operation image is displayed after the user clicks the mouse on the remote panel. Therefore, in the comparative example, it takes a total of 2*tcc+tci until the operation image is switched by the update. The total was 5 seconds or more when measured under a predetermined system environment. As the predetermined system environment here, there is cited an example in which the communication path between the terminal device 2c and the image forming apparatus 1c is such a very long communication path as to extend from Japan via the overseas reception server apparatus 3 and base server apparatus 4.

In contrast, in the present embodiment, the mouse-down operation and the mouse-up operation are coordinated. Thus, in the present embodiment, as compared with the comparative example, when measured under the same system environment as the predetermined system environment described above, the reaction time of the remote panel to the user operation was about 3.0 to 3.2 seconds, and the improvement of the reaction speed by 40% was achieved. As described above, in the present embodiment, it is possible to provide an efficient communication system in the remote panel function which is a remote operation function of the image forming apparatus.

Then, an application scene of the present system 100 will be described to describe that the advantages described above are beneficial. The provision of the remote panel can be used by, for example, an operator who is far away from the image forming apparatus 1. Examples of the operator include an IT (Information Technology) administrator, a serviceman, and a reseller engineer. These operators can perform troubleshooting and training for end users without visiting the site where the image forming apparatus 1 is installed. For example, as a scene in which the remote panel is used, the following scenes (1) and (2) can be assumed.

(1) An IT administrator in a company in which the image forming apparatus 1 is installed uses the terminal device 2 to directly access and use the image forming apparatus 1 from the same intranet.

(2) A serviceman or a reseller engineer outside the company in which the image forming apparatus 1 is installed uses the terminal device 2 to access and use the image forming apparatus 1 via the reception server apparatus 3 and the base server apparatus 4.

In the present embodiment, in any of the scenes (1) and (2), the operator can comfortably and quickly perform processing by using the present system 100 high in reaction speed of the remote panel.

Further, in the present embodiment, by adopting the determination based on such a communication time as described above, it is possible to perform the processing in which a plurality of operation events are coordinated only when the communication time is long. This advantage will be described in detail.

First, as illustrated in FIG. 2, the terminal device 2 may periodically perform image update in the background in order to display the change in the operation image of the image forming apparatus 1 in real time even when there is no operation by the user. It is preferable for the terminal device 2 to additionally record the communication time required for the periodic image update processing. Then, by adopting the determination described above, the terminal device 2 switches the communication content to perform the aggregation into one communication when it is determined that it is an environment low in communication speed such as an environment in which the communication time takes 0.5 second or more based on the communication time thus recorded when a user operation such as a mouse-click operation occurs on the browser. Specifically, the mouse-down operation event and the mouse-up operation event are aggregated into a mouse-click operation, which is a single event, and are transmitted to the image forming apparatus 1 side. Therefore, such an aggregation of the operation events can be performed only in an environment in which the communication speed is low. For example, in the environment high in communication speed, such an aggregation is not performed, and even when there is an operation event requesting an image change that cannot be represented by the aggregation, such an image change can be reflected.

### Application Example: Processing Example In Icon-Move Operation

The present system 100 is applicable not only to the mouse-click operation but also to a plurality of other operation events. Here, a description will be presented citing a move operation of an object such as an icon, namely a drag operation as an example. The icon-move operation can also be said to be an example of a range specification operation. Therefore, the following description can be applied to a range specification operation other than the move operation of an object such as an icon, for example, such as an operation of selecting a plurality of files from a file list contained in the operation image. First, such a range specification operation will be described.

The range specification operation such as an icon-move operation can be defined by an operation including a third event, which is an operation event of starting specification of a selection range, and a fourth event, which is an operation event of expanding the selection range. In this case, it results in that the first information which the terminal device 2 transmits to the image forming apparatus 1 side includes the third event and the fourth event as the predetermined plurality of operation events described above. In the case of the move operation of an icon or the like, it results in that the third event corresponds to the mouse-down operation, the fourth event corresponds to the mouse-move operation, and the first information includes operation events of the mouse-down operation and the mouse-move operation.

Further, the range specification operation can be defined as an operation including a fourth event that is an operation event for expanding the selection range and a fifth event that is an operation event for ending the specification of the selection range. In this case, it results in that the first information includes the fourth event and the fifth event as the predetermined plurality of operation events described above. In the case of the move operation of an icon or the like, it results in that the fourth event corresponds to the mouse-move operation, the fifth event corresponds to the mouse-up operation, and the first information includes operation events of the mouse-move operation and the mouse-up operation.

Further, when such fourth and fifth events as described above are coordinated, it is necessary to detect the fourth event. In this case, it is sufficient for the terminal device 2 to apply thinning processing of removing some operation events from the series of operation events received by the operation unit 23. The thinning processing may be, for example, processing of removing the operation events before the moving amount of the mouse reaches a predetermined amount. Thus, the fourth event to be coordinated with the fifth event can be detected as a move event that was performed immediately before the fifth event was received.

When such thinning processing is applied, the predetermined plurality of operation events may be defined as a plurality of operation events obtained by removing some of the series of operation events received by the terminal device 2. Note that such thinning processing can similarly be applied not only to the application example described here, but also to the processing described with reference to FIG. 1 to FIG. 7.

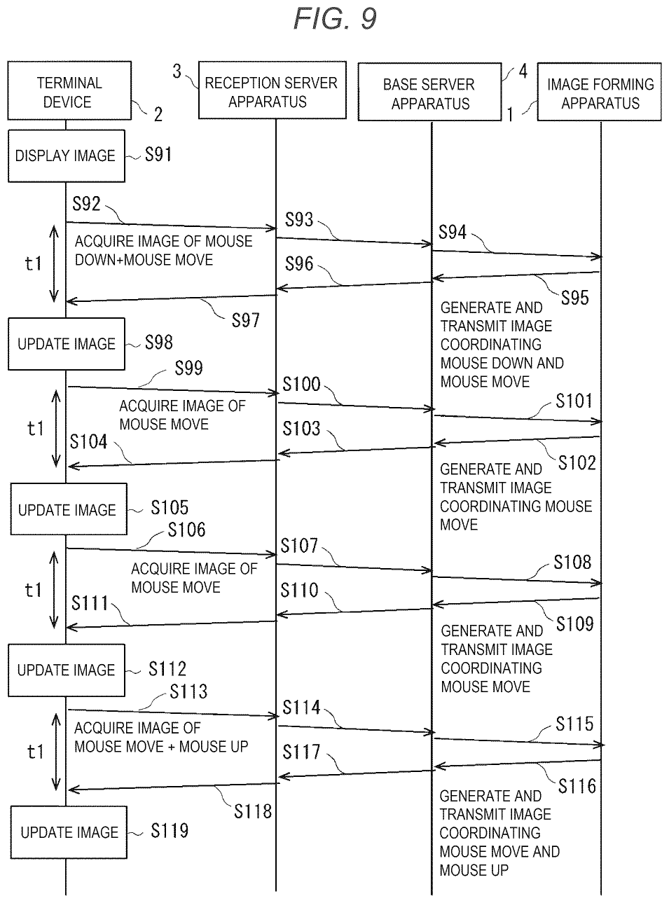

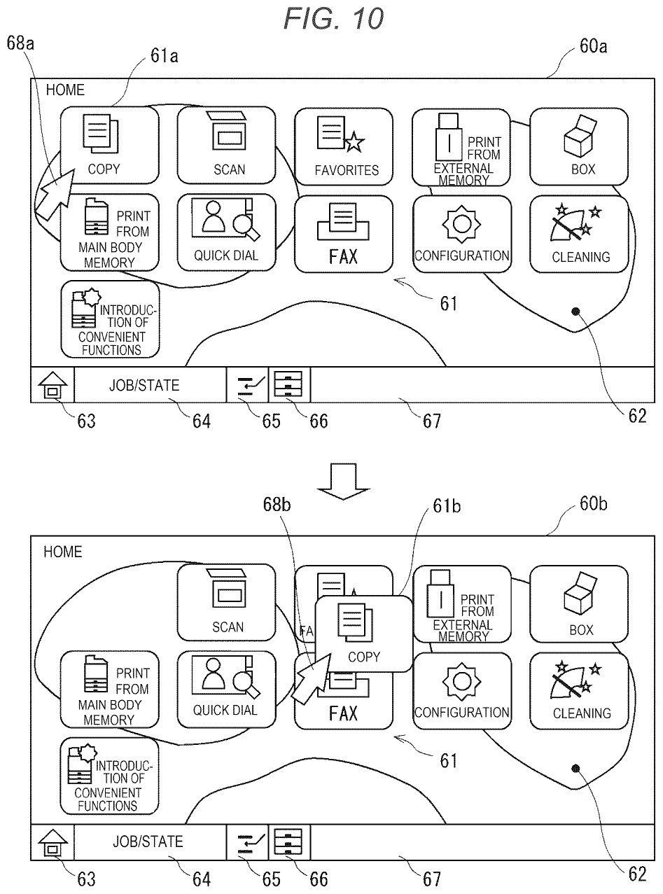

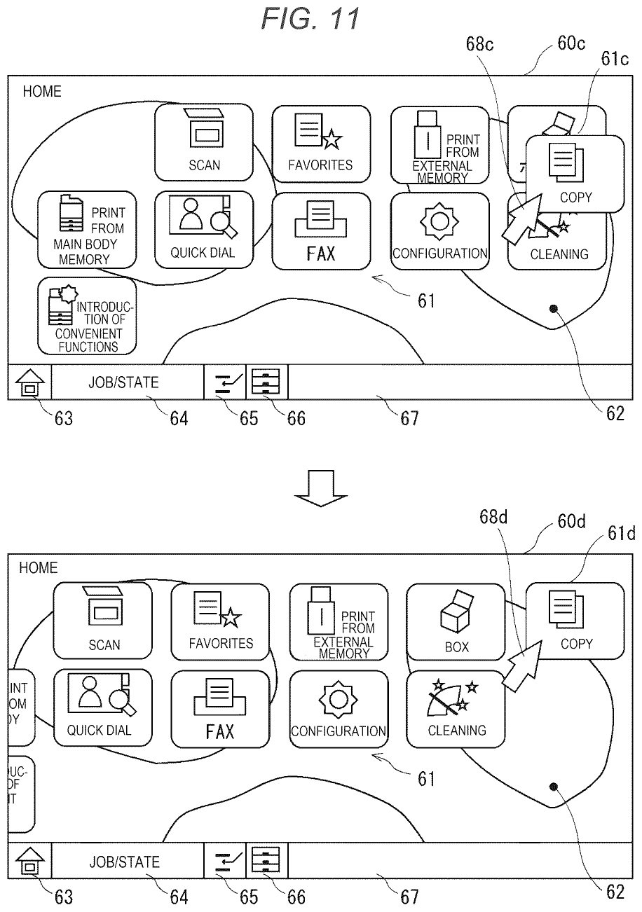

A processing example in the icon-move operation in the present system 100 will be described using FIG. 9 to FIG. 11. FIG. 9 is a flowchart illustrating the processing example when performing the icon-move operation in the present system 100. FIG. 10 is a schematic diagram illustrating a transition example of a display image in the processing example in FIG. 9. FIG. 11 is a schematic diagram illustrating the transition example of the display image in the processing example in FIG. 9 subsequent to FIG. 10.

First, similarly to step S61 in FIG. 6, the terminal device 2 displays an operation image such as an operation image 60a in FIG. 10 (step S91). Note that the operation image 60a is exemplified by the same image as an operation image 60s. In FIG. 10, it results in that in the operation image 60a, an operation is received in a state in which the cursor 68 of the mouse is displayed at, for example, a predetermined position.

Then, when the terminal device 2 receives the mouse-down operation and the mouse-move operation to the operation image 60a in the operation unit 23, the terminal device 2 requests the reception server apparatus 3 to acquire the next operation image, that is, the operation image reflecting that operation (step S92). In this case, in step S92, it results in that the mouse-down and mouse-move operations are collectively contained in the acquisition request of the operation image as the first information. Here, the description will be presented citing an example in which the mouse-down operation is performed on the icon 61a of the copy function.

It results in that in response to the acquisition request of the operation image, the image forming apparatus 1 receives (steps S93, S94) this request similarly to steps S63, S64. The image forming apparatus 1 updates the operation image for the terminal device 2 so that the operation image corresponds to the mouse-down operation and the mouse-move operation, and then transmits (steps S95 to S97) the first display information to the terminal device 2 similarly to steps S65 to S67.

The terminal device 2 updates the operation image based on the first display information thus received (step S98). With this update, it results in that the operation image 60a makes the transition to an operation image 60b in which the icon 61a and a cursor 68a of the copy function are moved to an icon 61b and a cursor 68b, respectively.

Subsequently, the terminal device 2 continues the move operation of moving the icon 61b on the operation image 60b to thereby request the reception server apparatus 3 to acquire the next operation image (step S99). In this case, a plurality of move operations that remain in the thinning processing may be coordinated and contained in the acquisition request of the operation image as the first information.

It results in that in response to the acquisition request of the operation image, the image forming apparatus 1 receives (steps S100, S101) this request similarly to steps S93, S94. The image forming apparatus 1 updates the operation image for the terminal device 2 so that the operation image corresponds to the mouse-move operation, and then transmits (steps S102 to S104) the first display information to the terminal device 2 similarly to steps S95 to S97.

The terminal device 2 updates the operation image based on the first display information thus received (step S105). With this update, it results in that the operation image 60b makes the transition to an operation image 60c in FIG. 11 in which the icon 61b and a cursor 68b of the copy function are moved to an icon 61c and a cursor 68c, respectively.

Subsequently, by the terminal device 2 continuing the move operation of moving the icon 61c on the operation image 60c, substantially the same processing as in steps S99 to S105 is performed (steps S106 to S112). Thus, it results in that the operation image 60c makes the transition to an operation image (not shown).

Subsequently, the terminal device 2 requests the reception server apparatus 3 to acquire the next operation image by performing the mouse-up operation after continuing the move operation of moving the icon corresponding to the icon 61c on this operation image (step S113). In this case, in step S113, it results in that the mouse-down and mouse-up operations are collectively contained in an acquisition request of the operation image as the first information.

It results in that in response to the acquisition request of the operation image, the image forming apparatus 1 receives (steps S114, S115) this request similarly to steps S93, S94. The image forming apparatus 1 updates the operation image for the terminal device 2 so that the operation image corresponds to the mouse-move operation and the mouse-up operation, and then transmits (steps S116 to S118) the first display information to the terminal device 2 similarly to steps S95 to S97.

The terminal device 2 updates the operation image based on the first display information thus received (step S119). With this update, it results in that the operation image 60c makes the transition to an operation image 60d in FIG. 11 in which the icon 61c and the cursor 68c of the copy function are moved to an icon 61d and a cursor 68d, respectively. In particular, since the icon 61c reaches the right end of the operation image 60c in the operation image 60c, the operation image 60d after the transition becomes an operation image in which other icons of the icon group 61 are moved to the left. On this occasion, the background image 62 may also be moved to the left together with the other icons described above. Note that the operation image displayed in step S112 is an image between the operation image 60c and the operation image 60d. Note that as shown in FIG. 9, the communication time required for each communication is represented as the t1, and the communication time required for the series of communications is 4*t1.

Note that the transition examples illustrated in FIG. 10 and FIG. 11 are illustrative only. For example, it is also possible to start moving the other icon groups leftward before the icon selected is completely moved to the right end of the screen by moving the mouse. That is, in the examples of FIG. 10 and FIG. 11, there is cited the example in which the other icons are also moved at the stage when the icon as the move target reaches the end of the operation image, but the other icons can also be moved in the opposite direction with the move of the icon as the move target before the icon reaches the end.

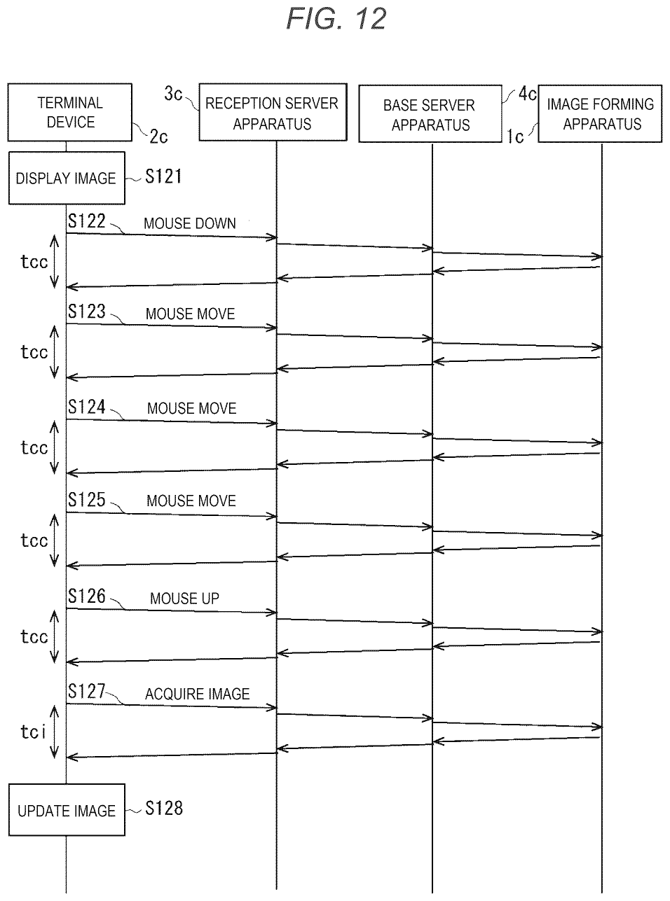

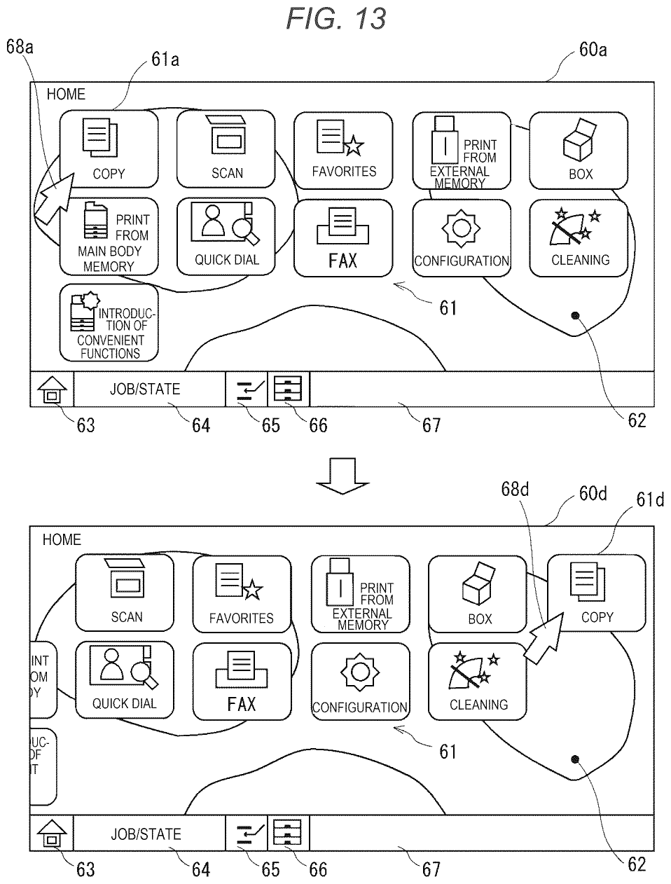

The advantages of the application example will be described by comparison with the comparative example using FIG. 12 and FIG. 13. FIG. 12 is a flowchart illustrating processing in the icon-move operation in the image forming system according to the comparative example. FIG. 13 is a schematic diagram illustrating a transition example of a display image in the processing of FIG. 12.

In the comparative example, the terminal device 2c displays (step S121) the operation image 60a illustrated in FIG. 10 and FIG. 13 similarly to step S91. Then, the terminal device 2c receives a mouse-down operation on the operation image 60a, transmits the information to the reception server apparatus 3, and requests the response thereto (step S122). It results in that the request is thereafter received by the image forming apparatus 1c on substantially the same path as in FIG. 9. It results in that the image forming apparatus 1c that received this request performs a response to the reception of the request via the base server apparatus 4 and the reception server apparatus 3 on substantially the same path as in FIG. 9. The communication time it takes from the start of step S122 to the response is defined as a communication time tcc.

Then, in the terminal device 2c, the mouse-move operation is performed on the operation image 60a, the information is transmitted to the reception server apparatus 3, and the response is requested (step S123). It results in that the request is thereafter received by the image forming apparatus 1c on substantially the same path as in FIG. 9. It results in that the image forming apparatus 1c that received this request performs a response to the reception of the request via the base server apparatus 4 and the reception server apparatus 3 on substantially the same path as in FIG. 9. Then, it results in that such a mouse-move operation and the response thereto are performed in substantially the same manner (steps S124, S125).

Then, the terminal device 2c receives the mouse-up operation on the operation image 60a, transmits the information to the reception server apparatus 3, and requests the response thereto (step S126). It results in that the request is thereafter received by the image forming apparatus 1c on substantially the same path as in FIG. 9. It results in that the image forming apparatus 1c that received this request performs a response to the reception of the request via the base server apparatus 4 and the reception server apparatus 3 on substantially the same path as in FIG. 9.

Then, the terminal device 2c requests the reception server apparatus 3 to acquire the operation image thus updated (step S127). It results in that the request is thereafter received by the image forming apparatus 1c on substantially the same path as in FIG. 9. It results in that the image forming apparatus 1c that received this request performs a response to the reception of the request via the base server apparatus 4 and the reception server apparatus 3 on substantially the same path as in FIG. 9.

The terminal device 2c updates the operation image based on the response received (step S128). It results in that with this update, the operation image 60a makes the transition to the operation image 60d shown in FIG. 13. However, as illustrated in FIG. 12, when the move operations continuously occur, the image update processing is postponed.

As illustrated in FIG. 13, in the image forming system according to the comparative example, it results in that the operation image 60d is suddenly displayed when the user selects and moves the icon 61a with the mouse-down operation on the operation image 60a on the remote panel. That is, in the comparative example, it results in that the operation image 60a is suddenly switched to the operation image 60d without going through the operation images 60b and 60c illustrated in FIG. 10 and FIG. 11. Specifically, in the comparative example, a total of six communications, namely the mouse-down, mouse-move, mouse-move, mouse-move, and mouse-up operations, and image acquisition, are internally performed, and it takes a total of 5*tcc+tci until the operation image is switched by update. This total was 11 seconds or more when measured under the predetermined system environment described above.

In contrast, in the application example of the present embodiment, the operations are coordinated in the mouse-down and mouse-move operations, the mouse-move and mouse-up operations, and so on. Thus, in the present embodiment, as compared with the comparative example, when measured under the same system environment as the predetermined system environment described above, the reaction time of the remote panel to the user operation was about 8.0 to 8.4 seconds, and the improvement of the reaction speed by approximately 30% was achieved. As described above, in the application example of the present embodiment, it is possible to provide an efficient communication system in the remote panel function which is a remote operation function of the image forming apparatus. Further, in this application example, since the transition of the operation image is made in a stepwise manner compared to the comparative example, the convenience of the user is also enhanced.

The present system 100 can also be applied when the user performs a drag operation on the remote panel as in the application example described above. Further, in the present embodiment, the responsiveness of the drag operation can also be improved by such application.

### Another Network Configuration Example of Image Forming System

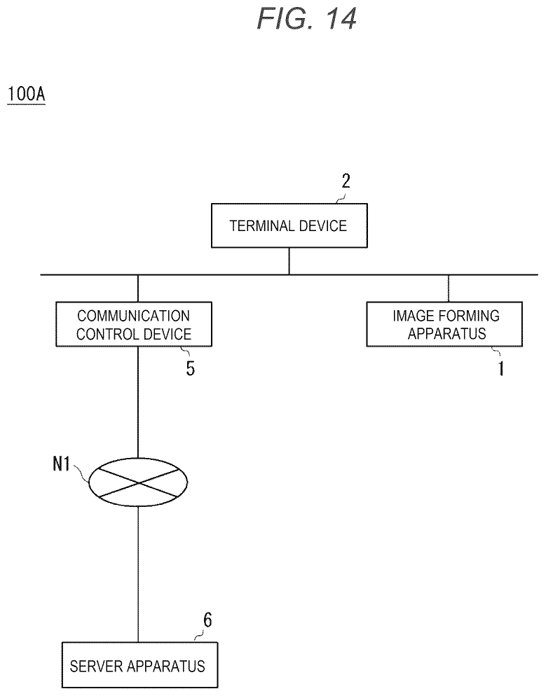

Another configuration example of the image forming system according to the present embodiment will be described using FIG. 14. FIG. 14 is a schematic block diagram illustrating another configuration example of the image forming system including the image forming apparatus and the terminal device according to the present embodiment.

The image forming system according to the present embodiment may be an image forming system 100A having a network configuration example as shown in FIG. 14. In the image forming system 100A, the terminal device 2 and the image forming apparatus 1 are coupled with a LAN (Local Area Network), and a communication control device 5 such as a router is coupled to the LAN. The LAN may be, for example, a LAN of a company in which the image forming apparatus 1 is installed. The communication control device 5 is a device that controls communication between devices in the LAN and a network N1. To the network N1, server apparatuses 6 such as the reception server apparatus 3 and the base server apparatus 4 are coupled. Obviously, the network configuration that can be applied in the present embodiment is not limited to those illustrated in FIG. 1 and FIG. 14.

### Other Modified Examples

The present disclosure is not limited to the embodiment described above, and can appropriately be modified without departing from the scope of the present disclosure. For example, the image forming apparatus applied to the image forming system according to the present embodiment can widely be applied to a copy machine, a facsimile machine, a composite machine provided with these functions, and so on, as can be understood from the operation image in FIG. 7 and so on.

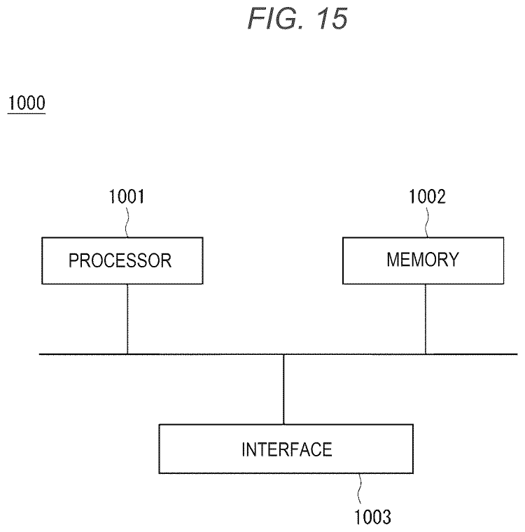

Further, the apparatuses provided to the image forming system according to the embodiment described above may include, for example, the following hardware configuration. FIG. 15 is a diagram showing an example of a hardware configuration of an apparatus.

An apparatus 1000 illustrated in FIG. 15 may include a processor 1001, a memory 1002, and an interface 1003. The interface 1003 may include, for example, a communication interface, an interface with a sensor, and an input-output device, which are necessary depending on the apparatus.

The processor 1001 may be, for example, a CPU, a GPU (Graphics Processing Unit), or an MPU (Micro Processor Unit) also referred to as a microprocessor. The processor 1001 may include a plurality of processors. The memory 1002 is formed of, for example, a combination of a volatile memory and a nonvolatile memory. Functions of the apparatuses are implemented by the processor 1001 reading a program stored in the memory 1002 and executing the program while exchanging necessary information via the interface 1003.

Further, the program described above includes an instruction group (or a software code) for causing a computer to implement one or more functions described in the embodiment when loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD), and other memory techniques. Further, examples of the computer-readable medium or the tangible storage medium include, but are not limited to, a CD-ROM, a digital versatile disc (DVD), a Blu-ray (registered trademark) disc, other optical disc storage, a magnetic cassette, a magnetic tape, a magnetic disk storage, or other magnetic storage devices. The program may be transmitted on a transitory computer-readable medium or a communication medium. Examples of the transitory computer-readable medium or the communication medium include, but are not limited to, electrical, optical, acoustic or other forms of propagation signals.

Although the present disclosure is described hereinabove with reference to the above embodiment, the present disclosure is not limited only to the configuration of the above embodiment, and the present disclosure obviously includes various variations, modifications, and combinations that can be made by those skilled in the art within the scope of the disclosure set forth in the appended claims of the present application.

What is claimed is:

1. An image forming apparatus comprising:
a communication unit;
a display configured to display an operation image;
a transmission processor configured to transmit display information based on the operation image displayed on the display to a terminal device via the communication unit; and
a reception processor configured to receive an operation event which was received by the terminal device from the terminal device via the communication unit, wherein
when the reception processor receives first information including a predetermined plurality of operation events, the transmission processor transmits, as the display information, first display information representing a response result to the predetermined plurality of operation events represented by the first information to the terminal device.

2. The image forming apparatus according to claim 1, wherein
the first information includes, as the predetermined plurality of operation events, a first event that is an operation event of starting designation of selection and a second event that is an operation event of ending the designation of the selection.

3. The image forming apparatus according to claim 1, wherein
the first information includes, as the predetermined plurality of operation events, a third event that is an operation event of starting specification of a selection range and a fourth event that is an operation event of expanding the selection range.

4. The image forming apparatus according to claim 1, wherein
the first information includes, as the predetermined plurality of operation events, a fourth event that is an operation event of expanding a selection range and a fifth event that is an operation event of ending specification of the selection range.

5. The image forming apparatus according to claim 1, wherein
the predetermined plurality of operation events are a plurality of operation events obtained by removing some of a series of operation events received by the terminal device.

6. The image forming apparatus according to claim 1, wherein
the transmission processor is configured to transmit the display information as information to be displayed on a browser of the terminal device.

7. The image forming apparatus according to claim 1, wherein
the communication unit is configured to communicate with the terminal device via at least one information processing device.

8. A terminal device comprising:
an operation unit;
a communication unit;
a reception processor configured to receive display information based on an operation image displayed on a display of an image forming apparatus from the image forming apparatus via the communication unit;
a display configured to display an operation image based on the display information received by the reception processor; and
a transmission processor configured to transmit an operation event received by the operation unit to the image forming apparatus via the communication unit, wherein
the transmission processor is configured to transmit first information including a predetermined plurality of operation events received by the operation unit to the image forming apparatus, and
the reception processor is configured to receive first display information representing a response result to the predetermined plurality of operation events represented by the first information from the image forming apparatus as the display information when the transmission processor transmits the first information.

9. The terminal device according to claim 8, wherein
the first information includes, as the predetermined plurality of operation events, a first event that is an operation event of starting designation of selection and a second event that is an operation event of ending the designation of the selection.

10. The terminal device according to claim 8, wherein
the first information includes, as the predetermined plurality of operation events, a third event that is an operation event of starting specification of a selection range and a fourth event that is an operation event of expanding the selection range.

11. The terminal device according to claim 8, wherein
the first information includes, as the predetermined plurality of operation events, a fourth event that is an operation event of expanding a selection range and a fifth event that is an operation event of ending specification of the selection range.

12. The terminal device according to claim 8, wherein
the predetermined plurality of operation events are a plurality of operation events obtained by removing some of a series of operation events received by the operation unit.

13. The terminal device according to claim 8, wherein
the predetermined plurality of operation events are a plurality of operation events determined based on a communication time it takes from transmission of the operation event to reception of the display information as a response of the transmission with respect to communication with the image forming apparatus by the communication unit.

14. The terminal device according to claim 8, wherein
the predetermined plurality of operation events are a plurality of operation events which are received when a communication time it takes from transmission of the operation event to reception of the display information as a response of the transmission is longer than a predetermined time with respect to communication with the image forming apparatus by the communication unit.

15. The terminal device according to claim 8, wherein
the reception processor is configured to receive the display information as information to be displayed on a browser of the terminal device.

16. The terminal device according to claim 8, wherein
the communication unit is configured to communicate with the image forming apparatus via at least one information processing device.

17. An operation method comprising:
executing, by an image forming apparatus including a communication unit and a display configured to display an operation image, transmission processing of transmitting display information based on the operation image displayed on the display to a terminal device via the communication unit; and
executing, by the image forming apparatus, reception processing of receiving an operation event, which was received by the terminal device, from the terminal device via the communication unit, wherein
in the transmission processing, when first information including a predetermined plurality of operation events was received in the reception processing, first display information representing a response result to the predetermined plurality of operation events represented by the first information is transmitted to the terminal device via the communication unit as the display information.
